(19) United States
(12) Patent Application Publication
(10) Pub. No.: US 2006/0124119 A1
(43) Pub. Date: Jun. 15, 2006

(54) Method for cutting diamond

(76) Inventor: Naotake Shuto, Miyagi (JP)

Correspondence Address: WENDEROTH, LIND & PONACK, L.L.P., 2033 K STREET N. W., SUITE 800, WASHINGTON, DC, 20006-1021, US

(21) Appl. No.: 11/354,122

(22) Filed: Feb. 15, 2006

Related U.S. Application Data
(62) Division of application No. 10/894,128, filed on Jul. 20, 2004.

(51) Int. Cl. B28D 5/00

(52) U.S. Cl. 125/30.01

(57) ABSTRACT

To provide a diamond rendering reflective light off the table goldenly brilliant by making a proportion thereof symmetry at any place viewed from an upper face, a side face or a bottom face, first reference lines, second reference lines crossing the first reference lines at right angles and third reference lines equally dividing the first reference lines and the second reference lines into four equal parts, respectively are provided. A first arc line is made by intersections of the reference lines. The approximately regular hexadecagon shaped table is established by connection of the intersections of the reference lines with the first arc line. Fourth reference lines dividing the third reference lines into two equal parts and a second arc line with a circle concentric with and larger than the first arc line is made. Star facets are established by connection of the intersections among the fourth reference lines and the second arc line with the top of the table. Upper main facets are established by connection of intersections of a diamond outward appearance and the first and the third reference lines with intersections of the fourth reference lines and the second arc line.

This application is a divisional application of application Ser. No. 10/894,128, filed Jul. 20, 2004.

### BACKGROUND OF THE INVENTION

1. Field of the Invention

This invention relates to a method for cutting diamond, and proportions and brightness of a diamond formed by the cutting method.

2. Related Art

In general, a value of a polished diamond is determined by the 4C's, i.e. Carat (Weight), Clarity (Transparency), Color and Cut. Although these 4C's are important respectively, the evaluating of a diamond is generally done by Color, Clarity (Transparency), Cut and Carat (Weight) in the mentioned order.

However, before a diamond cutting method was invented, there had not at all been recognition that a diamond had been a beautiful object. Namely, there had been recognition that a diamond had been a mere hard stone. What caused a diamond which had been recognized before to be a mere hard stone to come to be recognized to be a beautiful thing was the development of the techniques for brightening the diamond beautifully by cutting the same. Therefore, a diamond cutting method has been considered important.

It can be said that the brightness of a diamond can be obtained by cutting the same, and a diamond subjected to an excellent cutting process increases in brightness and glitter Under the circumstances, stress is laid on a cutting method on a diamond market. Therefore, when the beautifulness of a diamond is taken into consideration, it can also be said that the order of importance for the evaluation of the beautifulness of a diamond is Cut, Color, Clarity (Transparency) and Carat (Weight).

In such a cut evaluation method, proportions, symmetry and polished condition of a diamond are collectively evaluated, and graduated as a cut grade, which constitutes one of barometers used when a consumer purchases a diamond.

However, a diamond is valuable in itself, so that there is a case where stress is laid more on its dimensions and weight by reducing an area to be cut thereof than on its beautifulness and glitter shown by cutting the same. This causes the proportions of a diamond to be deteriorated in some cases.

Therefore, in recent years, the balance of a diamond as a whole has come to be seriously considered, and importance has also been attached to the 4C's+S (Symmetry) in which Symmetry is added to the 4C's mentioned above as important elements for evaluating a diamond.

Thus, since a cut is very important for the evaluation of a diamond, the techniques for a diamond cutting method has heretofore been studied in various respects. A round brilliant cut and the techniques disclosed in JP-A-2000-5993 and JP-U-3078636 have been known. Out of these techniques, the round brilliant cut is famous.

A diamond subjected to a round brilliant cut is a fifty-eight-faced polyhedron, and formed so that the rays of light entering the diamond are totally reflected on surfaces of bottom portions thereof and shine beautifully. It is said that the reflected light is dispersed and varies to seven colors.

According to the techniques disclosed in JP-A-2000-5993, reference lines are provided a diamond by setting an angle determined by dividing an angle of a circumference of a circle of 360° by a number obtained by multiplying 3 by an integral number thereof. The diamond as a whole is then cut into 65 faces or 86 faces.

According to the techniques disclosed in JP-U-3078636, cut surfaces provided on a bottom portion of a pavilion, i.e. cross-shaped cut surfaces are seen from a table surface.

When a diamond is similar to a raw ore thereof, the brightness and coloring thereof come to be just as those of a related art diamond, in which there is not variations of an individual diamond. Therefore, new brightness of a diamond has been demanded, and, above all, the development of a diamond glittering in a golden color has been expected.

In a diamond cutting method based on the techniques for obtaining round brilliant cuts, the rays of light entering a diamond are totally reflected on a surface of a bottom portion thereof and glitters beautifully. However, the reflected light is the same as that obtained in a related art diamond cutting method, and this reflected light is unable to express a tone of a gold color.

The invention disclosed in JP-A-2000-5993 is unable to express a tone of a gold color. Since reference lines are provided on a diamond by setting an angle obtained by dividing an angle of a circumference of a circle of 360° by a number obtained by multiplying 3 by an integral number of 3, the diamond is not symmetric.

The invention disclosed in JP-U-3078636 is not a method of varying a tone of color of a diamond. According to this invention, a cross-shaped cut surface is merely seen from a table surface, and the diamond is not symmetric.

Therefore, it is an object of the present invention to provide a diamond having excellent proportions, i.e. a diamond substantially symmetric when the diamond is seen from any positions on upper, side and bottom surfaces thereof with the light reflected on a table surface having the glitter of a golden color.

### SUMMARY OF THE INVENTION

The present invention provides as a first invention thereof constituting a concrete means to attain the above object a method of cutting a diamond having a girdle, a crown formed on an upper side of the girdle and provided with a table at an upper portion thereof, and a pavilion formed on a lower side of the girdle, including the steps of providing a first reference line on a diamond, providing on the diamond a second reference line crossing the first reference line at right angles thereto, providing on the diamond third reference lines dividing a sector between the first and second reference lines into four equal parts, providing on the diamond a first arc-connected line having a diameter equal to that of the table and passing an intersection of these reference lines, connecting intersections of these reference lines and first arc-connected line together to define the table of a substantially 16-cornered right polygonal shape, providing on the diamond fourth reference lines dividing sectors between the third reference lines into two equal parts to form a second arc-connected line concentric with and larger than the first arc-connected line, connecting intersections of the fourth reference lines and second arc-connected line and a center of the table together to define star facets, connecting intersections of the girdle of the diamond and first to third reference lines and intersections of the fourth reference line and second arc-connected line together to define upper main facets as well as paired upper girdle facets between the upper main facets and the outermost edge of the diamond, and cutting the diamond along contours of the respective defined facets.

The diamond may be cut by setting a maximum diameter of the table to substantially 53% of the diameter of the girdle with respect to a base percentage of 100% representing the diameter of the girdle.

Also, the diamond is cut by setting the height of the diamond as a whole, the height of the crown, the height of the pavilion and a maximum width of the girdle to substantially 66.4%, substantially 15.7%, substantially 50% and substantially 1.3% respectively with respect to a base percentage of 100% representing the diameter of the girdle.

Further, the diamond may cut by setting an angle to be formed between the reference line of the girdle and crown to substantially 33°.

Furthermore, the diamond is cut by setting an angle to be formed between the reference line of the girdle and pavilion to substantially 42° to 48°.

The present invention provides as a second invention thereof proportions of a diamond having a girdle, a table-carrying crown formed on an upper portion of the girdle, and a pavilion formed on a lower portion of the girdle, a total height of the diamond, the height of the crown, the height of the pavilion, a maximum width of the girdle and a maximum diameter of the table being set to substantially 66.4%, substantially 15.7%, substantially 50%, substantially 1.3% and substantially 53% respectively with respect to a base percentage of 100% representing the diameter of the girdle, to thereby form a table of a substantially 16-cornered right polygonal shape as well as star facets, upper main facets and upper girdle facets, the pavilion being divided by keel lines opposed to the substantially 16-cornered right polygonal shape of the table, lower girdle facets and lower main facets being formed in each divisional area, a culet being formed in a central section of a bottom portion.

The diamond may have 65-faced cuts established by the table provided on the crown, star facets, upper main facets and upper girdle facets, 49-faced cuts being established by the lower girdle facets, lower main facets and culet which are formed on the pavilion, a total of 114-faced cuts being established.

The cuts in all faces except the culet may have substantially symmetric proportions when the diamond is seen from any of an upper surface, a side surface and a bottom surface thereof.

Further, the diamond may have an angle of substantially 33° formed between the reference line of the girdle and crown.

Furthermore, the diamond may have an angle of substantially 42° to 48° formed between the reference line of the girdle and pavilion.

Owing to such a diamond cutting method or proportions of the resultant diamond formed or set in this manner, a diamond obtained has proportions in which the diamond is substantially symmetric when the diamond is seen from any of the upper surface, side surface and bottom surface thereof, and is able to have the light reflected on the table glitter in a golden color.

### BRIEF DESCRIPTION OF THE DRAWING

FIG. 1 is a schematic top view of a diamond in an embodiment of the present invention;

FIG. 2 is a schematic side view of the diamond;

FIG. 3 is a schematic bottom view of the diamond;

FIG. 4 is an explanatory view of a method of cutting a crown portion of the diamond; and

FIG. 5 is a schematic sectional view describing the same diamond as a whole.

### DETAILED DESCRIPTION OF PREFERRED EMBODIMENT

A preferred embodiment of the present invention will be described in detail with reference to the accompanying drawings.

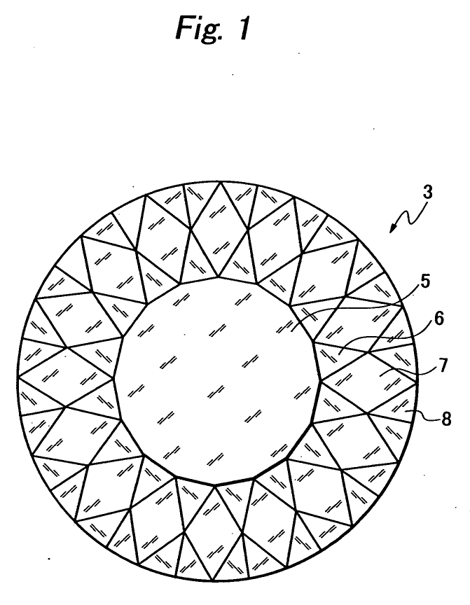

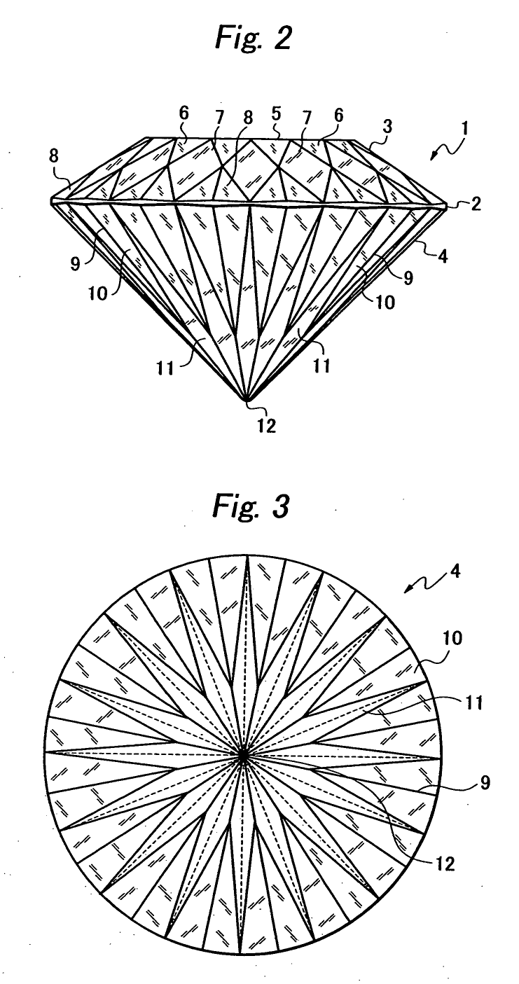

FIGS. 1 to 5 show an embodiment of the present invention, and descriptions of the same portions will be given by using the same reference numerals. A cut diamond of proportions 1 includes a girdle 2, a crown 3 formed on an upper portion of the girdle, and a pavilion 4 formed on a lower portion of the girdle. The crown 3 formed on an upper portion of the girdle 2 is provided with a table 5.

The table 5 provided on the crown 3 is formed to a substantially 16-cornered right polygonal shape, and has star facets 6 along the sides of the table. Upper main facets 7 are formed so that upper end portions thereof are directed toward the center of the table, the facets 7 contacting and lying between adjacent star facets 6. Among the adjacent upper main facets, paired upper girdle facets 8 are formed.

The pavilion 4 is divided into areas along keel lines 9 opposed to the sides of the substantially 16-cornered right polygonal shape of the table 5. In the divisional areas, lower girdle facets 10 and lower main facets 11 are formed, and a culet 12 in a central section of a bottom portion.

Therefore, in the diamond having proportions 1, one face is established by the table 5 provided on the crown 3, and 64 faces by the star facets 6, upper main facets 7 and upper girdle facets 8, i.e., 65 faces on the crown 3. 48 faces are established by the lower girdle facets 10 and lower main facets 11 formed on the pavilion 4, and one face by the culet. Namely, 49 faces are established on the pavilion 4. Accordingly, the diamond as a whole has 114-faced cuts.

Since the crown 3 of the diamond of proportions 1 is formed correspondingly to the table 5 provided on the crown and having a substantially 16-cornered right polygonal shape, the diamond as a whole is balanced well, i.e., substantially symmetric in top view, side view and bottom view thereof.

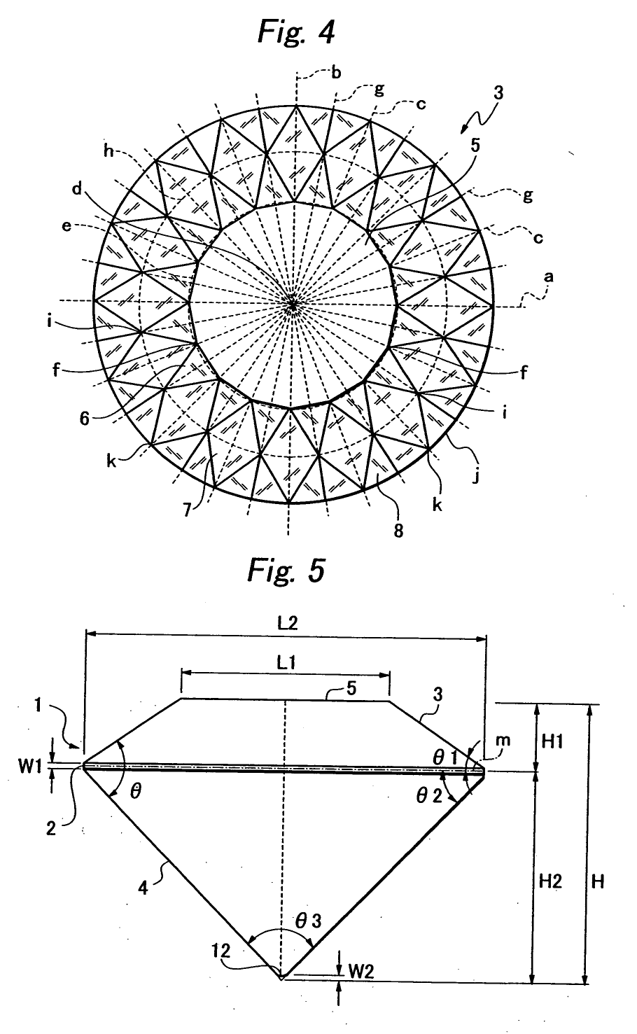

A method of cutting the crown 3 is shown in FIG. 4. In order to cut the table 5 of the crown 3 in the condition shown in FIG. 4, a first reference line a is provided on the diamond, and a second reference line b crossing the first reference line at right angles thereto on the same, third reference lines c which divide a sector between the first and second reference lines into four equal parts being provided on the same. A first arc-connected line e having a diameter L1 passing an intersection d of these reference lines is provided, and the table 5 of a substantially 16-cornered right polygonal shape is formed by connecting intersections f of these reference lines and the first arc-connected line e.

Furthermore, fourth reference lines g dividing sectors between the third reference lines c are provided, and a second arc-connected line h larger than and concentric with the first arc-connected line e. An intersection i of the fourth reference lines g and second arc-connected line h and the center of the table 5 are connected together to establish star facets 6. An intersection k of the outermost edge j of the diamond and first reference line a, an intersection k of the second reference line b and third reference lines c, and the intersection of the fourth reference lines g and second arc-connected line h are connected together to establish upper main facets 7 and paired upper girdle facets 8 between adjacent upper main facets 7 and the outermost edge j of the diamond. When the diamond is cut along contours of these established facets, the crown 3 is formed.

The outermost edge j is shown in phantom, along which the diamond is cut when the girdle 2 is formed. The outermost edge j is cut to form the girdle 2 of a diameter L2. When the diameter L1 of the first arc-connected line e is set to substantially 53% with respect to a base percentage of 100% representing the diameter L2 of the girdle 2. As a result, a maximum diameter of the table 5 becomes substantially 53% of that of the girdle 2.

When the crown 3 is thus formed, the light entering the table 5 can be reflected more finely, and it becomes possible to have the diamond glitter by reflecting spectra of light of tones, which are different from those of the spectra of light reflected on the table 5, on the star facets 6, upper main facets 7 and upper girdle facets 8.

The construction of each part of the diamond will now be described with reference to FIG. 5 which is a sectional view thereof. The diamond is formed by setting a total height H thereof, the height H1 of the crown 3, the height H2 of the pavilion 4 and a maximum width W1 of the girdle 2 to 66.4%, 15.7%, substantially 50% and substantially 1.3% respectively with respect to a base percentage of 100% representing the diameter L2 of the girdle 2.

The crown 3 is set to an angle θ1 of substantially 33° with respect to a reference line m of the girdle 2, the pavilion 4 to an angle of θ2 of substantially 42° to 48° and preferably substantially 45° with respect to the same, so that an angle θ formed between the circumferential surface of the crown 3 and pavilion 4 becomes substantially 75° to 81° and preferably 78°.

Since the total height H of the diamond, the height of the crown H1, the height H2 of the pavilion 4 and the angle θ2 to which the pavilion is set with respect to the reference line m of the girdle 11 are thus set, an angle θ3 of a bottom portion of the pavilion is set to 84° to 96° and preferably substantially 90°.

The lower girdle facets 10 and lower main facets 11 of the pavilion 4 are formed along the keel lines 9 by the same method as that used heretofore. During the formation of these facets, the width W2 of the culet 12 is set to 1.6% with respect to a base percentage of 100% representing the diameter L2 of the girdle.

In the related art round brilliant cuts, an angle formed between the reference line of the girdle and pavilion is set to substantially 41°, while, in the diamond of proportions 1 according to the present invention, an angle θ2 to which the pavilion 4 is set with respect to the reference line m of the girdle is set to substantially 42° to 48° and preferably to 45°. As a result, the height H2 of the pavilion 4 becomes larger than that of the pavilion of a related art diamond.

When the angle θ2 formed between the pavilion 4 and the reference line m is set to substantially 45°, the table 5 glitters in a golden color, and looks as if a pattern of a multi-petal flower similar to a chrysanthemum floated. The star facets 6, upper main facets 7 and upper girdle facets 8 glitter like aureoles in tones of green, blue or purple.

When the angle θ2 is reduced to smaller than 45°, i.e. substantially 42° to 45°, the table 5 glitters in a tone of a golden color dose to red, and the star facets 6, upper main facets 7 and upper girdle facets 8 glitter like aureoles in tones of green, blue or purple.

When the angle θ2 is increased to larger than 45° i.e. substantially 45° to 48°, the table 5 glitters in a tone of color dose to white. The table 5 glitters in two kinds of tones of colors, i.e. in a golden color at the central portion thereof, and in white at a circumferential portion thereof. The star facets 6, upper main facets 7 and upper girdle facets 8 glitter like aureoles in tones of green, blue and purple.

When the light enters the crown 3, the table 5 glitters in golden color since the table 5 reflects a tone of color having a long spectrum. The star facets 6, upper main facets 7 and upper girdle facets 8 glitter like aureoles in tones of green, blue or purple since these facets reflect tones of colors having a short spectrum. These aureoles look as if the aureoles turned when the point of viewing the aureoles is moved.

In the 114-faced cuts of the table 5 in the present invention of a substantially 16-cornered right polygonal shape, the light reflected on the crown 3 turns into light on a finer nano-scale as compared with the light reflected on a related art 58-faced body of round brilliant cuts and the table of a 12-cornered polygonal shape of 86-faced cuts, so that the reflected light in an atomized state reflects in an eddy condition on the table 5. Therefore, the reflection on the table 5 becomes strong, so that the reflected light looks like reflected light of a tone of color stronger and denser than that of the incident light.

Owing to an increase in the diffusibility of the light in the interior of the pavilion 4, the wave motion only from which the particles of the light are excluded out of the wave motion and particles of the light is reflected, so that it becomes possible to express the color proper to the light.

As described above, the present invention provides a method of cutting a diamond having a girdle, a crown formed on an upper side of the girdle and provided with a table at an upper portion thereof, and a pavilion formed on a lower side of the girdle, including the steps of providing a first reference line on a diamond, providing on the diamond a second reference line crossing the first reference line at right angles thereto, providing on the diamond third reference lines dividing a sector between the first and second reference lines into four equal parts, providing on the diamond a first arc-connected line having a diameter equal to that of the table and passing an intersection of these reference lines, connecting these reference lines and the first arc-connected line together to define the table of a substantially 16-cornered right polygonal shape, providing on the diamond fourth reference lines dividing sectors between the third reference lines into two parts to form a second arc-connected line, connecting the intersections of the fourth reference lines and second arc-connected line and a center of the table together to define star facets, connecting the intersections of the girdle of the diamond and first to third reference lines and the intersections of the fourth reference line and second arc-connected line together to define paired upper main facets as well as upper girdle facets between the upper main facets and the outermost edge of the diamond, and cutting the diamond along contours of the respective defined facets. This makes it possible that the diamond has substantially symmetric proportions in any of top view, side view and bottom view thereof, so that the balance of the diamond as a whole can be expressed beautifully with the table rendered able to glitter in golden color.

The present invention provides as a second invention thereof a method of cutting a diamond having a girdle, a table-carrying crown formed on an upper portion of the girdle, and a pavilion formed on a lower portion of the girdle, a total height of the diamond, the height of the crown, the height of the pavilion, a maximum width of the girdle and a maximum diameter of the table being set to substantially 66.4%, substantially 15.7%, substantially 50%, substantially 1.3% and substantially 53% respectively with respect to a base percentage of 100% representing the diameter of the girdle, to thereby form a table of a substantially 16-cornered right polygonal shape as well as star facets, upper main facets and upper girdle facets, the pavilion being divided by keel lines opposed to the substantially 16-cornered right polygonal shape of the table, lower girdle facets and lower main facets being formed in each divisional area, a culet being formed in a central section of a bottom portion. This makes it possible that the diamond has substantially symmetric proportions in any of top view, side view and bottom view thereof, so that the balance of the diamond as a whole can be expressed beautifully with the table rendered able to glitter in golden color, all of which constitute the excellent effects of the present invention.

As described, the diamond cutting method and the proportions of the resultant diamond formed or set according to the invention provide superior advantages that a diamond obtained has proportions in which the diamond is substantially symmetric when the diamond is seen from any of the upper surface, side surface and bottom surface thereof, so that the balance of the diamond as a whole can be expressed beautifully. Beside, since the reflected light in an atomized state reflects in an eddy condition on the table, the reflection on the table becomes strong, so that the reflected light looks like reflected light of a tone of color stronger and denser than that of the incident light, with the table rendered able to glitter in golden color.

What is claimed is:

1. A method for cutting a diamond having a girdle, a crown formed on an upper side of the girdle and provided with a table at an upper portion thereof, and a pavilion formed on a lower side of the girdle, comprising the steps of:
providing a first reference line on a diamond, providing on the diamond a second reference line crossing the first reference line at right angles thereto, providing on the diamond third reference lines dividing a sector between the first and second reference lines into four equal parts, providing on the diamond a first arc-connected line having a diameter equal to that of the table and passing an intersection of these reference lines, and connecting intersections of these reference lines and first arc-connected line together to define the table of a substantially 16-cornered right polygonal shape,
providing on the diamond fourth reference lines dividing sectors between the third reference lines into two equal parts to form a second arc-connected line concentric with and larger than the first arc-connected line, connecting intersections of the fourth reference lines and second arc-connected line and a center of the table together to define star facets,
connecting intersections of an outermost edge of the diamond and first to third reference lines and intersections of the fourth reference line and second arc-connected line together to establish upper main facets, and paired upper girdle facets between the upper main facets and the outermost edge of the diamond, and
cutting the diamond along the contours of the established facets.

2. A diamond cutting method according to claim 1, wherein the table is cut by setting a maximum diameter of the table to substantially 53% of the diameter of the girdle with respect to a base percentage of 100% representing the diameter of the girdle.

3. A diamond cutting method according to claim 1, wherein the diamond is cut by setting the height of the diamond as a whole, the height of the crown, the height of the pavilion and a maximum width of the girdle to substantially 66.4%, substantially 15.7%, substantially 50% and substantially 1.3% respectively with respect to a base percentage of 100% representing the diameter of the girdle.

4. A diamond cutting method according to claim 1, wherein the diamond is cut by setting an angle to be formed between the reference line of the girdle and crown to substantially 33°.

5. A diamond cutting method according to claim 1, wherein the diamond is cut by setting an angle to be formed between the reference line of the girdle and pavilion to substantially 42° to 48°.
